(19) United States
(12) Patent Application Publication
(10) Pub. No.: US 2002/0053554 A1
(43) Pub. Date: May 9, 2002

(54) CIRCUIT BREAKER FOR DISCONNECTING AN ELECTRICAL APPARATUS FROM ELECTRICAL NETWORK

(76) Inventors: ESA VIRTANEN, VAASA (FI); TAPANI TIITOLA, VAASA (FI); VESA VIRTANEN, VAASA (FI)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 09/355,649

(22) PCT Filed: Feb. 4, 1998
(86) PCT No.: PCT/FI98/00103

(30) Foreign Application Priority Data
Feb. 6, 1997 (FI) 970504

(51) Int. Cl. H01H 33/70

(52) U.S. Cl. 218/154

(57) ABSTRACT

The invention relates to a circuit breaker, which is in a fault situation arranged to disconnect an electrical apparatus, such as a distribution transformer, from an average voltage network or a high voltage network at each terminal. At least one lik-spring mechanism (9 to 12) is arranged at a shaft (6) of the circuit breaker for holding contacts (1, 2) live in connected position and for pushing them apart to the extreme disconnected position when disconnected, while the shaft (6) is brought over the dead spot of its turning. For an initial release the shaft (6) is at each phase provided with a lever arm (8) each lever arm at each phase being arranged to turn by means of a trip pin (19) of a striker (18) of a high voltage fuse (17) the shaft (6) of the circuit breaker and thus the moving contacts (1) of all phases from said connected position over the dead spot of turning said shaft

The invention relates to a circuit breaker, which is in a fault situation arranged to disconnect an electrical apparatus, such as a distribution transformer, from an average voltage network or a high voltage network at each terminal, and which comprises at each phase at least one fixed contact and a moving contact to be engaged with and disengaged from the fixed contact, each moving contact being fastened to a turning shaft of the circuit breaker and the circuit breaker being simultaneously electrically connected in series with a high voltage fuse situated at each phase.

Because of more and more stringent quality requirements of the electric power, the amount of interruptions in the use of a power line should be minimized and their duration shortened as much as possible. When a fault occurs in a distribution transformer, the length of interruption in the use of the line feeding electric current is shortened by immediate automatic disconnection of the transformer from the electrical network, because the line can be held live all the time during fault diagnosis and during preparations for changing the faulty transformer.

Oil-insulated distribution transformers have the special problem that, if a fault occurs in a winding of a transformer, the transformer oil in the transformer tank is heated and a gas mixture is generated in the tank. At its worst, the pressure in the tank rises so high that the tank tears and transformer oil leaks out on the ground causing environmental problems, risk of ground or other fire, or in the worst case, danger of explosion threatening human lives. Maintenance personnel is subjected to a particularly great danger when examining a faulty live transformer.

Distribution transformers and many special transformers are characterised in that their protective devices must operate without auxiliary supply voltages, possibly located outdoors, subjected to severe environmental conditions, for which reason the solutions known in the environment of high voltage transformers and implemented by means of protective relays and circuit breakers cannot be used economically in this connection.

A known solution for possible faults in a distribution transformer is to provide the primary side of the transformer with high voltage fuses. This solution has, however, the drawback that a two- or three-phase transformer remains live in a fault situation, because each phase is protected by its own fuse. After the fuse of one phase of a three-phase transformer has blown, current still flows therein. Additionally, when normal current limiting fuses are used, a co-ordination problem occurs, meaning a situation in which the current is not disconnected by fuse blow out, but remains flowing and causes a pressure rise inside the fuse until the fuse explodes. Standard IEC 282-1 (1985) does not require a breaking capacity of high voltage fuses at low over-currents (generally below 3*Iₙ). Further, for instance a cycle short circuit may cause such a low fault current that it cannot be indicated from the strength of the primary current and especially not protected by means of fuses, but a fault of this kind still causes a temperature and pressure rise in the transformer tank, and local oil heating causes gas generation.

French Patent 2 712 730 discloses a solution in which the primary circuit of a transformer at each phase comprises two high voltage fuses of different types in series with a three-phase circuit breaker. The circuit breaker opens according to the properties of the dielectric liquid of the transformer changing over a preset threshold value. This solution eliminates the coordination problem with fuse protection, but still leaves the transformer live at a reduced number of terminals in a fault situation, if the circuit breaker does not open. In addition, so much space is required for positioning the two fuses connected in series in connection with the transformer that the used standard transformer cannot be replaced as such by a solution of this kind without any alterations.

Among other close applications can be mentioned standard IEC 420 “High Voltage alternating current switch-fuse combinations”, which defines the electrical and operative properties of fuse circuit breakers intended for AC use in the average voltage area.

As far as fuse circuit breakers using high voltage fuses as a trigger are concerned, it can be mentioned that, because the requirements for rated current are even dozens of times higher than the different requirements for the application area of the invention, said fuse circuit breakers shall always in practice be provided with complicated mechanisms released by a trip pin of a fuse striker, for increasing the power. For instance, the circuit breaker of a 160 kVA distribution transformer shall have a rated current of 15 A, while the lowest rated currents of circuit breakers are 630 A.

The object of the present invention is to eliminate the above draw-backs. This object is achieved by means of a circuit breaker, which is characterised in that the shaft of the circuit breaker is provided with at least one link-spring mechanism for holding the contacts live in connected position and for pushing them apart to the extreme disconnected position when disconnected, while the shaft is brought over the dead spot of its turning, and that the shaft is at each phase provided with a lever arm, each lever arm being arranged to turn by means of a trip pin of a striker of the high voltage fuse the shaft of the circuit breaker and thus the moving contacts of all phases from said connected position over said dead spot of turning said shaft.

Because the breaker mechanism according to the invention always breaks the voltage of all phases in a fault situation, the windings of the transformer remain entirely without voltage and current, though the fuse of one phase only has blown. The faulty transformer does not warm up then and no explosion sensitive gas mixture is generated, for which reason it is safe to examine the transformer and to change it into a new one.

The problem with the co-ordination of the fuse is eliminated, because upon the fuse blowing out, the circuit breaker opens and disconnects the current, and an explosion of the fuse is thus avoided. In the solution of the invention, only one fuse is needed for each feeding phase. If the fuse is integrated into a feedthrough insulator, the transformer can be provided with mechanical dimensions which make it changeable for a conventional transformer without protection.

The circuit breaker of the transformer according to the invention is further characterised in that the circuit breaker can be tuned to a working condition at the assembly of the transformer. The release limit of the arrangement can be dimensioned in such a way that the circuit breaker does not open in any switching or overload situation of the transformer, but only if the transformer becomes faulty. The mechanism can thus be retuned to the working condition at the maintenance and repair of the transformer, and no separate outside mechanisms are then needed for the control of the circuit breaker.

In the following, the invention will be described in greater detail with reference to the attached drawings, in which

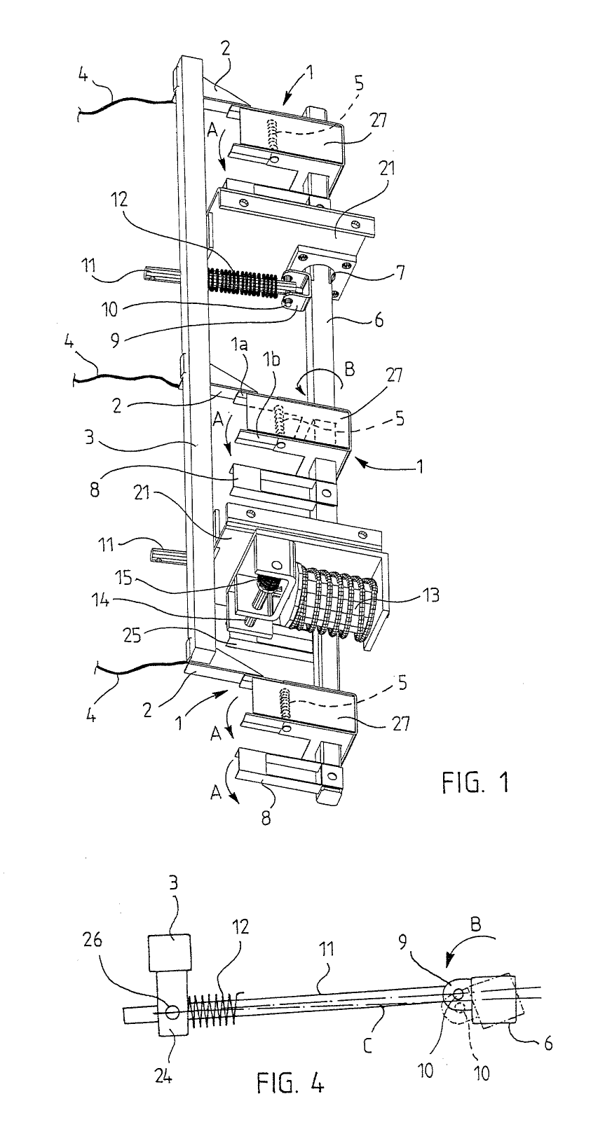

FIG. 1 shows a perspective view of a breaker mechanism,

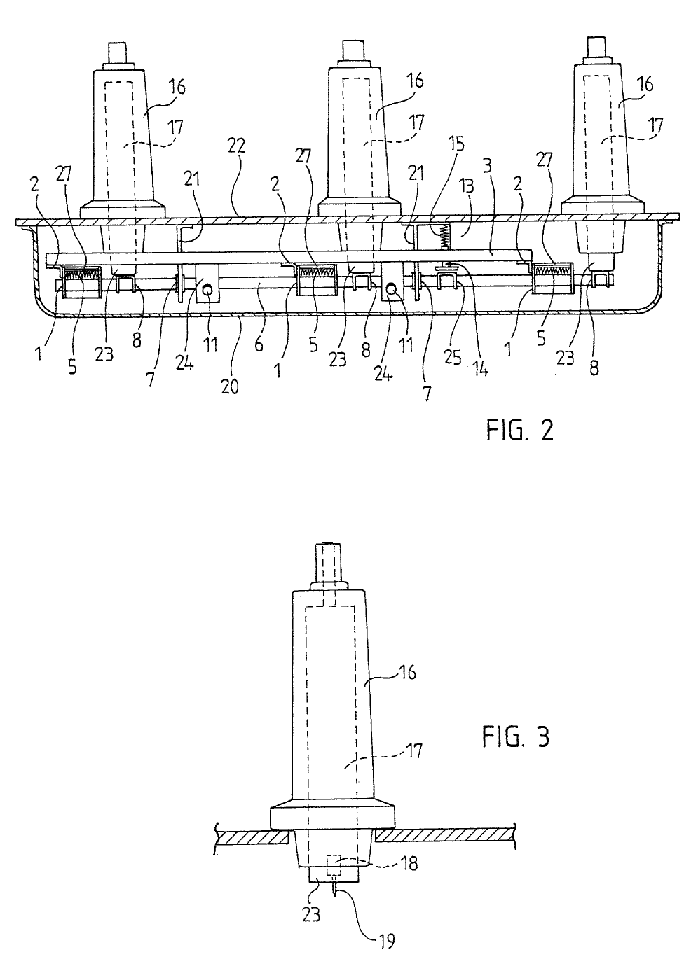

FIG. 2 shows a side view of the breaker mechanism of FIG. 1 positioned in a trough, to the cover of which are fastened high voltage fuses,

FIG. 3 shows in greater detail a feedthrough insulator according to FIG. 2, into which a fuse is integrated, and

FIG. 4 shows a general view of turning the shaft of the circuit breaker.

The basic components of a circuit breaker according to the invention are moving contacts 1 intended for each phase of a transformer and respective fixed contacts 2 cooperating with the moving contacts.

Ends 4 of a primary winding of the transformer are connected to the fixed contacts 2, which are fastened to a fastening rod 3 made of dielectric insulating material. On the other hand, the fastening rod 3 is fastened to frame parts 21 of the circuit breaker.

The U-shaped moving contacts 1 are mounted on a shaft 6, parallell with the fastening rod 3 and mounted in bearings on the frame parts 21 at points 7, to allow a revolution about its axis. The contacts 1 are arranged to act simultaneously by means of the shaft 6, and the contact force between the contacts 1 and 2 is each time given by a spring 5 tensioned between branches 1a and 1b of the moving contact 1. Further, because of the U-shape of the moving contacts 1, their contact force increases when the current increases, and consequently, the contact 1 endures a short circuit situation of the secondary side of the transformer and high currents caused by a fault in winding.

In accordance with FIGS. 2 and 3, the circuit breaker is immersed in a trough 20 filled with dielectric liquid, which trough guarantees the operation of the circuit breaker even though the casing (not shown in the drawings) surrounding the whole system has been leaking.

Each primary phase comprises a high voltage fuse 17 known from the use of fuse circuit breaker, which fuse is each time integrated into a feedthrough insulator 16 fastened to a cover 22 of the casing 20 and electrically connected in series with the circuit breaker.

When the breaker mechanism is in the closed position according to the FIGS. 1 and 2, an electrode 23 of the lower end of the fuse 17 is in contact with the shaft 6 of the moving contact 1 by means of a lever arm 8 each time arranged at the moving contact 1, while the moving contact 1 is connected to the fixed contact 2. At the lower end of the fuse 17, there is further a striker 18 tripping at the blow-out of the fuse. A substantial part of the striker 18 is a trip pin 19 bouncing out of the end of the fuse 17.

When the fuse 17 blows out, the movement of the trip pin 19 is transmitted to the shaft 6 by means of the lever arm 8.

The breaker mechanism comprises further at least one link-spring mechanism comprising a lug 9 fastened to the shaft 6, a tap 11 fastened to the lug with a cotter bolt 10, one end of the tap being fastened to the rod 3 by means of a support 24, and a pressure spring 12 mounted about the tap 11, which spring, in the closed position of the contacts 1 and 2, pushes slightly the breaker mechanism swung over the dead spot of turning the shaft 6 and prevents unintentional releases caused by impact or vibration. The dead spot of turning the shaft 6 signifies the line C shown in FIG. 4 (the line between one end of the tap 11, a fastening cotter 26 of the support 24, and the axis of the shaft 6), whereby the shaft 6 swings in the opposite direction when the cotter bolt 10 crosses said line C as a result of the operation of the trip pin 19. Accordingly, when the fuse 17 is operating, the operation of its trip pin 19 turns the shaft 6 and the moving contacts 1 of all phases from the closed position towards the open position over said dead spot.

After the shaft 6 has been brought over the dead spot of turning the shaft by the force of the trip pin 19, the force of the spring 12 of the link-spring mechanism continues turning the shaft 6 and thus the moving contacts 1 to the extreme open position at a sufficient speed so that the electric arc caused by the disconnected current breaks. This turning is shown in FIG. 1 by arrows A and B.

When the contacts 1 and 2 and also 1 and 23 open, two electric arcs in series increase the electric arc resistance and breaks the electric arc better than one contact. The breaking is based on the cooling phenomenon of the contact, caused by the oil used as dielectric liquid, and on a movement of the oil, which movement can be intensified by forming the moving contact 1 suitably or by providing it with a wing 27, for instance, which is arranged between the branches 1a and 1b of the contact 1.

Moreover, the breaker mechanism has been supplemented with a mechanical trip mechanism, comprising tight bellows 13 containing gas. When the pressure in the tank of the transformer or in the casing 20 of the breaker mechanism exceeds the preset threshold value, the bellows 13 sink down and trip a trip pin 14, which turns by the force of the spring 15 the shaft 6 and the contacts 1 of all phases from the closed position towards the open position over the dead spot of turning said shaft described above. Subsequently, the link-spring mechanism 9 to 12 opens the circuit breaker in the same way as at a release caused by a fuse. The operating point of over-pressure release depends slightly on the liquid temperature in the tank or in the casing 20, because the gas pressure inside the bellows 13 changes in accordance with the general formula p*V/T=constant.

Still another link-spring mechanism 9 to 12 is preferably fastened beside this arrangement, whereby these two mechanisms 9 to 12 guarantee a sufficient force for holding the connection and a sufficient force for pushing to the extreme open position in all situations.

In addition to the fuse and over-pressure protection, the system can also be supplemented with protections tripping on the basis of the temperature of the oil and the windings and on the basis of sinking liquid surface, which protections are not shown separately in the drawings. Temperature protections may comprise a temperature sensor arranged in connection with the circuit breaker, such as a bimetal means or a capillary provided with a trip pin. Correspondingly, the protection tripping by sinking liquid surface may comprise a float also provided with a trip pin. These pins are arranged to turn the shaft 6 of the circuit breaker by means of suitable lever arms over the dead spot of turning the shaft when the permitted temperature is exceeded and the permitted liquid-level value sinks in the same manner as in connection with the fuse and over-pressure protection described above.

Moreover, an electromechanical trigger can be arranged in connection with the circuit breaker for turning the shaft 6 of the circuit breaker by electric remote control, for instance, but otherwise in the above-described manner, and thus for disconnecting the contacts 1 and 2, when there is some other specific reason for this.

Auxiliary contact information on the state of the circuit breaker can additionally be detected by means of at least one auxiliary contact, for example to be transmitted by means of a remote control system to the operation supervisor.

The shaft 6 of the circuit breaker can also be brought through the walls of the structures surrounding the circuit breaker, whereby it is possible to arrange a mechanical outside display of position data and a retuning of the circuit breaker from outside the transformer.

It has to be noted further that the lever arm fastened to the shaft 6 and intended for the trigger means can also be integrated into the moving contact 1. Correspondingly, separate lever arms can be used for different triggers or some triggers may have a common lever arm.

The above specification of the invention is only intended to illustrate the invention. One skilled in the art may, however, implement its details within the scope of the attached claims in very many ways, in addition to those described above.

1. Circuit breaker, which is in a fault situation arranged to disconnect an electrical apparatus, such as a distribution transformer, from a medium voltage network or a high voltage network at each terminal, and which circuit breaker comprises at each phase at least one fixed contact (2) and a moving contact (1) to be engaged with and disengaged from the fixed contact, the circuit breaker being simultaneously electrically connected in series with a high voltage fuse (17) situated at each phase, wherein at least one link-spring mechanism (9 to 12) is arranged for holding the contacts (1, 2) live in connected position and for pushing them apart to the extreme disconnected position when disconnected, while the shaft (6) is brought over the dead spot of its turning by trip means (18, 19) characterised in that
each moving contact (1) is arranged to the turning shaft (6) of the circuit breaker,
the shaft (6) at each phase being provided with a lever arm (8), each lever arm being arranged to turn by means of the trip means constituting of a trip pin (19) and a striker (18) of the high voltage fuse (17), the common shaft (6) of the lever arm (8) and the moving contact (1) and thus the moving contacts (1) of all phases from said connected position over said dead spot of turning said shaft.

2. Circuit breaker according to claim 1, characterised in that it is arranged inside a casing of the electrical apparatus, such as a tank of a distribution transformer.

3. Circuit breaker according to claim 1 or 2, characterised in that it is immersed in a dielectric liquid.

4. Circuit breaker according to any of the preceding claims, characterised in that a trough (20) is arranged around the circuit breaker to keep the circuit breaker in the dielectric liquid.

5. Circuit breaker according to any of the preceding claims, characterised in that a high voltage fuse (17) is arranged at least partially inside a feedthrough insulator (16), which is fastened to the wall of the casing of the electrical apparatus or to a cover (22) of the trough (20).

6. Circuit breaker according to any of the preceding claims, characterised in that one end (23) of the high voltage fuse (17) serves at each phase as one fixed contact of the circuit breaker.

7. Circuit breaker according to any of the preceding claims, characterised in that the lever arm (8) is an independent means.

8. Circuit breaker according to any of the claims 1 to 6, characterised in that the lever arm is integrated into a moving contact.

9. Circuit breaker according to any of the preceding claims, characterised in that bellows (10) are arranged in connection with the circuit breaker, which bellows are provided with a trip pin (14) arranged to turn the shaft (6) of the circuit breaker by means of the lever arm over the dead spot of turning the shaft, when the pressure of the dielectric liquid exceeds the preset threshold value.

10. Circuit breaker according to any of the preceding claims, characterised in that a bimetal means is arranged in connection with the circuit breaker, the means being provided with a trip pin arranged to turn the shaft (6) of the circuit breaker by means of the lever arm over the dead spot of turning the shaft, when the temperature of the dielectric liquid exceeds the preset threshold value.

11. Circuit breaker according to any of the preceding claims, characterised in that a float is arranged in connection with the circuit breaker, the float being provided with a trip pin arranged to turn the shaft (6) of the circuit breaker by means of the lever arm over the dead spot of turning the shaft, when the liquid level is below the preset value.

12. Circuit breaker according to any of the preceding claims, characterised in that an electromechanical trigger is arranged in connection with the circuit breaker to turn the shaft (6) of the circuit breaker by means of the lever arm over the dead spot of turning the shaft.

13. Circuit breaker according to any of the preceding claims, characterised in that a temperature sensor, such as a capillary or a bimetal means, provided with a trigger is additionally arranged in connection with the circuit breaker, the trigger being arranged to turn the shaft of the circuit breaker by means of the lever arm over the dead spot of turning the shaft, when the temperature of the windings of the electrical apparatus exceeds the preset threshold value.

14. Circuit breaker according to any of the claims 9 to 13, characterised in that the lever arm is the same lever arm as that in connection with the high voltage fuse.

15. Circuit breaker according to any of the claims 9 to 13, characterised in that the lever arm is a separate lever arm intended for said means.

16. Circuit breaker according to any of the preceding claims, characterised in that the circuit breaker is provided with at least one auxiliary contact for transferring position data of the circuit breaker.

17. Circuit breaker according to any of the claims 2 to 15, characterised in that at least one end of the shaft (6) of the circuit breaker extends through the wall of the casing of the electrical apparatus and is provided with a position indicating device for detecting the position of the circuit breaker from outside of the apparatus.

18. Circuit breaker according to any of the claims 2 to 17, characterised in that at least one end of the shaft (6) of the circuit breaker extends through the wall of the casing of the electrical apparatus to make it possible to tune the circuit breaker to the operating position from outside the apparatus.
